(19) United States
(12) Patent Application Publication
(10) Pub. No.: US 2007/0013701 A1
(43) Pub. Date: Jan. 18, 2007

(54) Method for distributing messages, computer, and program

(76) Inventors: Junichi Segawa, Kawasaki-shi (JP); Hideki Yoshida, Tokyo (JP); Tetsuro Kimura, Tama-shi (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/151,408

(22) Filed: Jun. 14, 2005

(30) Foreign Application Priority Data
Jul. 15, 2004 (JP) 2004-208884

(51) Int. Cl. G06F 15/16

(52) U.S. Cl. 345/502

(57) ABSTRACT

According to an aspect of the present invention, in a virtual space unit area, a message is distributed among computers using a physical topology based on a physical network. This avoids delaying operations in a computer which are related to those in another computer on a virtual space and taking a roundabout route on the physical network for distribution. On the other hand, outside the virtual space unit area, a message is distributed among computers using a virtual topology based on a virtual space. Consequently, the computers forming the physical topology can be limited to those present in the virtual space unit area. It is thus possible to reduce the amount of communication required to measure physical network distances.

### CROSS-REFERENCE TO RELATED APPLICATIONS

This application is based upon and claims the benefit of priority from prior Japanese Patent Application No. 2004-208884, filed Jul. 15, 2004, the entire contents of which are incorporated herein by reference.

### BACKGROUND OF THE INVENTION

The present invention relates to a method for distributing messages in which computers distributively managing a virtual space distribute messages to one another, as well as a related computer and a related program, and to a method for distributing messages which avoids taking a roundabout route or causing a delay in data distribution, to enable data to be promptly updated, as well as a related computer and a related program.

A role playing game, a military simulator, a 3D chat, and the like are applications that generate a logical space on a computer so that various objects can act in the space. The logical space provided by such applications is generally called a “virtual space”.

The recent development of communication infrastructures such as ADSL (Asymmetric Digital Subscriber) and FTTH (Fiber To The Home) has enabled a plurality of computers to share a virtual space through a network.

A known technique for sharing a virtual space is, for example, a P2P (Peer to Peer/Personal to Personal) system in which a plurality of computers distributively manage the virtual space. The P2P system does not require any computer centrally managing data indicating the statuses of various objects on the virtual space. Instead, each of the plurality of computers has a copy of a part or all of the data. Upon changing the data while processing the virtual space, each computer notifies the other computers of the contents of the change through message communications.

In this case, ideally, all the computers are preferably connected directly to one another. However, with this form, the number of connections that must be managed by each computer increases consistently with the number of computers. Consequently, an enormous management load is imposed on the computers. Thus, a network connection form is actually used in which some of the computers are connected directly together, while the remaining computers are connected indirectly together via other computers. The network connection form is generally called a “topology”. Thus, the network connection form will be referred to as a topology below.

A first and second techniques are known which are used to construct a topology. The first technique is a method of constructing a topology on the basis of coordinate values on a virtual space which are associated with each computer (see, for example, Y. Kawahara, N. Matsumoto, H. Morikawa, and T. Aoyama, “Distributed Communication Architecture for Network Type Virtual Environment”, Technical Report of The Institute of Electronics, Information and Communication Engineers, IN-2001-229, (2002, 3)). The coordinate values on the virtual space are normally those of objects (avatars) controlled by the computers on the virtual space.

The first method utilizes the nature that the closer avatars are to each other on a virtual space, the more likely the avatars are to interact with each other.

For example, it is assumed that avatars a and b are located close to each other and that an avatar c is located away from both avatars a and b. When the avatar a raises its hand, a computer controlling the avatar b must receive a data update message indicating that the hand has been raised, from a computer controlling the avatar a, as promptly as possible, to update the data on the avatar a and draw and display the updated avatar a. This is because the avatars a and b, located close to each other, are likely to interact with each other. On the other hand, a computer controlling the distant avatar c need not update the data on the avatar a promptly. With some applications, the computer controlling the avatar c has no data on the avatar a. This is because the avatars a and c, located away from each other, are unlikely to interact with each other.

The first technique constructs a topology on the basis of coordinate values on a virtual space. Accordingly, this technique is effective for data updates between the avatars a and b. Further, the first technique limits data distribution to nearby areas and does not distribute data to distant areas. This makes it possible to reduce the amount of data transferred as well as throughput.

However, the first technique can quickly transmit data over one hop but is often slow in transmitting data over at least two hops. This situation occurs when computers controlling avatars located close to each other on a virtual space are located away from each other on a physical network. In other words, when data is distributed via the avatars located close to each other on the virtual space, a roundabout route is taken on the physical network. This delays data transmissions over at least two hops.

Such roundabout routes are likely to be taken when messages are propagated over a wide range. This disadvantageously increases the total traffic on the physical network.

The second technique is a system that constructs an efficient topology on the basis of locations on a physical network (see, for example, C-K. Toh “Ad-hoc Mobile Wireless Network”, translated by KOZO KEIKAKU ENGINEERING Inc., published by KYORITSU SHUPPAN CO., LTD). The second technique actually transmits data to a computer and measures a distance on the physical network on the basis of a reply to the data. A topology is then constructed by connecting together computers located close to each other. However, if the second technique is applied to the P2P system, consisting of a large number of computers, it requires a large amount of communication in order to measure the distances between the computers.

Further, with the second method, computers managing avatars located close to each other on a virtual space may be located away from each other on a topology. Thus, with the second method, even though the avatars are located close to each other on the virtual space, operations of one avatar which are related to those of the other are disadvantageously likely to be delayed.

As described above, the first technique constructs a topology on the basis of coordinate values on a virtual space. Consequently, a roundabout route may disadvantageously be taken on a physical network in transmitting data. On the other hand, the second technique constructs a topology on the basis of distances on the physical network. Consequently, operations of an avatar which are related to those of another may disadvantageously be delayed on the virtual space. That is, the first and second techniques have problems contrary to each other. Further, the second technique entails an enormous communication load in order to measure distances and is thus difficult to apply.

### BRIEF SUMMARY OF THE INVENTION

It is an object of the present invention to provide a method for distributing messages which can avoid taking a roundabout route or causing a delay in data distribution between computers based on a P2P system while reducing the amount of communication required to measure distances, thus enabling prompt data updates, as well as a related computer and a related program.

According to a first aspect of the present invention, there is provided a method for distributing messages in which if a memory is provided and a plurality of computers each partly managing a virtual space are connected together, when a certain computer updates a status of the virtual space, a message for the update is distributed to the other computers by sequentially transmitting the message to an adjacent computer, the method comprising: providing a virtual topology for a plurality of virtual space unit areas into which the virtual space is divided, the virtual topology being formed by connecting computers each representing the adjacent virtual space unit areas on the basis of coordinate values of each of the computers on the virtual space; providing a physical topology for each of the virtual space unit areas, the physical topology being formed by connecting computers controlling, respectively, objects contained in the virtual space unit area on the basis of distances between the computers on a physical network; storing address information on adjacent computers pre-connected adjacent to each computer on the virtual topology;

storing address information on adjacent computers pre-connected adjacent to each computer on the physical topology; causing a certain adjacent computer to receive the message for the update; causing the adjacent computer to extract a message ID from the message; causing the adjacent computer to determine whether the same message ID has been recorded; causing the adjacent computer to end a process on the message, when the same message ID has been recorded; causing the adjacent computer to record the message ID, when the same message ID has not been recorded; causing the adjacent computer to read information on an address of the adjacent computer on the virtual or physical topology from the memory on the basis of the message, when the same message ID has not been recorded; and causing the adjacent computer to distribute the message to an adjacent computer on the basis of the read address information.

According to a second aspect of the present invention, there is provided a computer used in a method for distributing messages in which if a plurality of computers each partly managing a virtual space are connected together, when a certain computer updates a status of the virtual space, a message for the update is distributed to the other computers by sequentially transmitting the message to an adjacent computer, the computer comprising: a virtual topology adjacent computer storage device configured to store address information on adjacent computers connected adjacent to each computer on the virtual topology for a plurality of virtual space unit areas into which the virtual space is divided, the virtual topology being formed by connecting computers each representing the adjacent virtual space unit areas on the basis of coordinate values of each of the computers on the virtual space; a physical topology adjacent computer storage device configured to store address information on adjacent computers connected adjacent to each computer on the physical topology for each of the virtual space unit areas, the physical topology being formed by connecting computers controlling, respectively, objects contained in the virtual space unit area on the basis of distances between the computers on a physical network; an extracting device, receiving the message for the update, configured to extract a message ID from the message; a determination device configured to determine whether the same message ID has been recorded; an end device to end a process on the message, when the same message ID has been recorded; a record device to record the message ID, when the same message ID has not been recorded; a device configured to read information on an address of the adjacent computer from each of the storage devices, when the same message ID has not been recorded; and a device configured to distribute the message an adjacent computer on the basis of to the read address information.

In each of the first and second aspects, a virtual topology in which representative computers connect virtual space unit areas together is combined with a physical topology in which in each virtual space unit area, the representative computer is connected to the remaining computers.

Thus, when a message for an update is to be propagated to all the computers, each computer uses the physical topology, based on a physical network, to distribute the message to adjacent computers located within the virtual space unit area. In contrast to the prior art, this avoids delaying operations of an avatar which are related to those of another on the virtual space and taking a roundabout route on the physical network in distributing data.

On the other hand, the computer uses the virtual topology, based on the virtual space, to distribute the message to adjacent computers outside the virtual space unit area. Consequently, the computers forming the physical topology can be limited to those within the virtual space unit area. In contrast to the prior art, it is possible to significantly reduce the amount of communication required to measure physical network distances.

Thus, the first and second aspects employ the configuration in which the physical and virtual topologies are combined together. This makes it possible to avoid taking a roundabout route or causing a delay in data distribution between computers based on the P2P system while reducing the amount of communication required to measure distances, thus enabling prompt data updates.

### BRIEF DESCRIPTION OF THE SEVERAL VIEWS OF THE DRAWING

FIGS. 1A and 1B are schematic diagrams illustrating topologies composed of a group of computers according to embodiments of the present invention;

FIG. 2 is a schematic diagram showing the configuration of each computer constituting the computer group according to a first embodiment of the present invention;

FIG. 3 is a flowchart illustrating process functions of a message receiving section according to the first embodiment;

FIG. 4 is a schematic diagram showing the configuration of a virtual topology adjacent computer managing section;

FIG. 5 is a schematic diagram showing the configuration of a physical topology adjacent computer managing section;

FIG. 6 is a flowchart illustrating process functions of a distribution destination determining section according to the first embodiment;

FIG. 7 is a schematic diagram illustrating an instructing method executed by a virtual topology charge area holding section according to the first embodiment;

FIG. 8 is a schematic diagram illustrating the instructing method executed by the virtual topology charge area holding section according to the first embodiment;

FIG. 9 is a schematic diagram illustrating a method for dividing a unit area which method is executed by a unit area specification information managing section according to the first embodiment;

FIG. 10 is a schematic diagram illustrating the method for dividing a unit area which method is executed by the unit area specification information managing section according to the first embodiment;

FIG. 11 is a schematic diagram illustrating the method for dividing a unit area which method is executed by the unit area specification information managing section according to the first embodiment;

FIG. 12 is a schematic diagram illustrating the method for dividing a unit area which method is executed by the unit area specification information managing section according to the first embodiment;

FIG. 13 is a flowchart illustrating process functions of a physical network distance measuring section according to the first embodiment;

FIG. 14 is a schematic diagram showing the configuration of an object managing section according to the first embodiment;

FIG. 15 is a schematic diagram showing the configuration of a message according to the first embodiment;

FIG. 16 is a flowchart illustrating operations for new participation according to the first embodiment;

FIGS. 17A and 17B are schematic diagrams illustrating the situation of specific examples according to the first embodiment;

FIG. 18 is a flowchart illustrating operations for new creation according to the first embodiment;

FIG. 19 is a flowchart illustrating operations for message distribution according to the first embodiment;

FIG. 20 is a flowchart illustrating process functions of a distribution destination determining section according to a second embodiment of the present invention;

FIGS. 21A and 21B are schematic diagrams illustrating a summary of a third embodiment of the present invention; and

FIG. 22 is a flowchart illustrating process functions added by the distribution destination determining section according to the third embodiment.

### DETAILED DESCRIPTION OF THE INVENTION

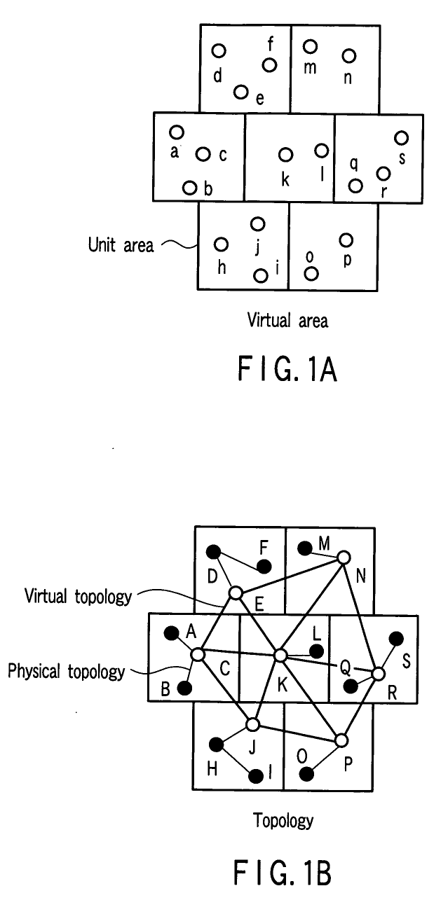

Embodiments of the present invention will be described below with reference to the drawings. Before describing the embodiments, topologies common to the embodiments will be described with reference to FIGS. 1A and 1B.

FIG. 1A shows that a plurality of avatars are present in a virtual space. Rectangles into which the virtual space is divided show virtual space unit areas. Circles show avatars located at respective coordinate values on the virtual space. The avatars are specific examples of objects each using one pair of coordinates on the virtual space which corresponds to a computer on a one-to-one basis. The pair of coordinates on the virtual space which corresponds to a computer on a one-to-one basis is also referred to as “virtual space coordinates”.

FIG. 1B shows computers controlling the avatars and their topology. In FIG. 1B, reference character A denotes a computer controlling an avatar a. Reference character B denotes a computer controlling an avatar b. Similarly, the avatars and the computers are denoted by upper and lower case letters of the same alphabets.

Computers having avatars in the same virtual space unit area manage the same virtual space unit area. For example, computers A, B, and C manage the virtual space unit area in which avatars a, b, and c are present. Computers D, E, and F manage the virtual space unit area in which avatars d, e, and f are present. Similarly, computers O and P manage the virtual space unit area in which avatars o and p are present. In FIG. 1B, white circles indicate computers individually representing the corresponding virtual space unit areas. Black circles indicate the remaining computers.

As seen in FIG. 1B, the links constituting a topology are classified into (1) those which extend across two adjacent virtual space unit areas and (2) those which are closed in the respective virtual space unit areas.

The links (1) relate to adjacent virtual space unit areas and link computers individually representing the corresponding virtual space unit areas. The links (1) constitute a topology based on the virtual space unit areas and are thus called a “virtual topology”.

The links (2) constitute a topology based on the distance between computers in a physical network and are thus referred to as a “physical topology”.

The virtual space unit area to which the computer A belongs is called the “virtual topology charge area” for the computer A.

With a virtual space application for the P2P system, it is necessary to determine which of the computers is responsible for a particular one of the plurality of areas in the virtual space. Here, the determined area for which the computer is responsible is called a “simulation charge area”. In first and second embodiments described below, the “virtual topology charge area” for a certain computer is the same as the “simulation charge area” for the computer. In a third embodiment described below, the “virtual topology charge area” for a certain computer is different from the “simulation charge area” for the computer.

### First Embodiment

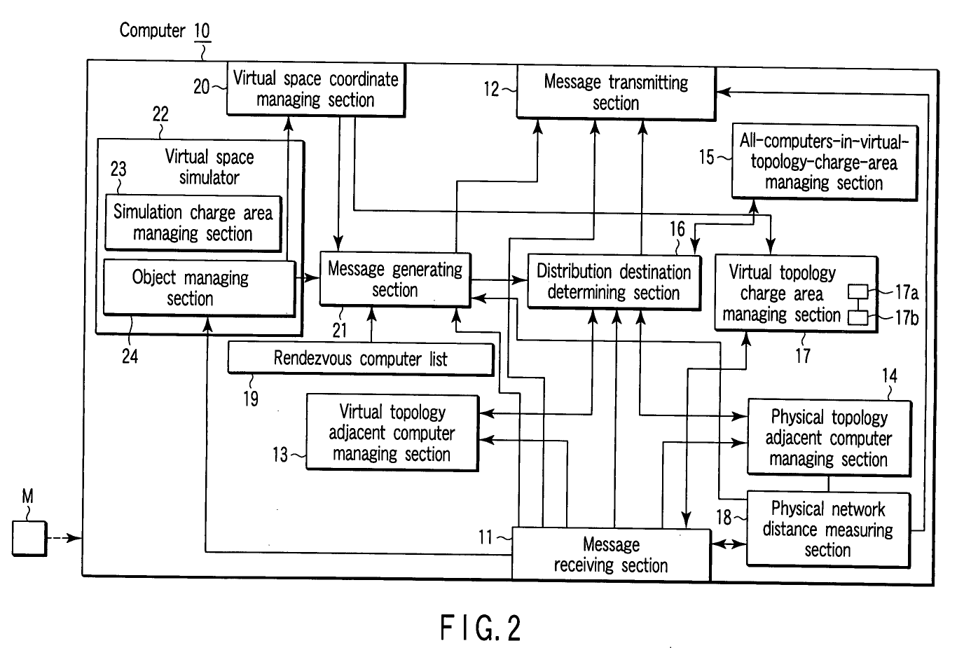

FIG. 2 is a schematic diagram showing the configuration of each computer constituting a group of computers according to the first embodiment of the present invention. Each computer 10 distributively manages a virtual space. The computer 10 comprises a message receiving section 11, a message transmitting section 12, a virtual topology adjacent computer managing section 13, a physical topology adjacent computer managing section 14, an all-computers-in-virtual-topology-charge-area managing section 15, a distribution destination determining section 16, a virtual topology charge area managing section 17, a physical network distance measuring section 18, a rendezvous computer list 19, a virtual space coordinate managing section 20, a message generating section 21, a virtual space simulator 22, a simulation charge area managing section 23, and an object managing section 24.

Each computer 10 may be implemented using a hardware device such as an IC chip which is tamper-resistant, or a combination of a hardware device and software. The software is pre-installed through a storage medium M or a network. The software comprises a program that allows the computer 10 to realize its functions. The form using the software can also be implemented in the embodiments described below.

The message receiving section 11 has a function for receiving messages transmitted by other computers, a function for analyzing the messages, and a function for transmitting messages to the distribution destination determining section 16, the physical network distance measuring section 18, the message generating section 21, or the object managing section 24 or requesting these sections to execute the respective processes, with reference to the managing sections 13, 14, and 17 on the basis of the analyses. The message receiving section 11 has a message ID recording section to record the IDs of processed messages. This prevents the same message from being repeatedly processed.

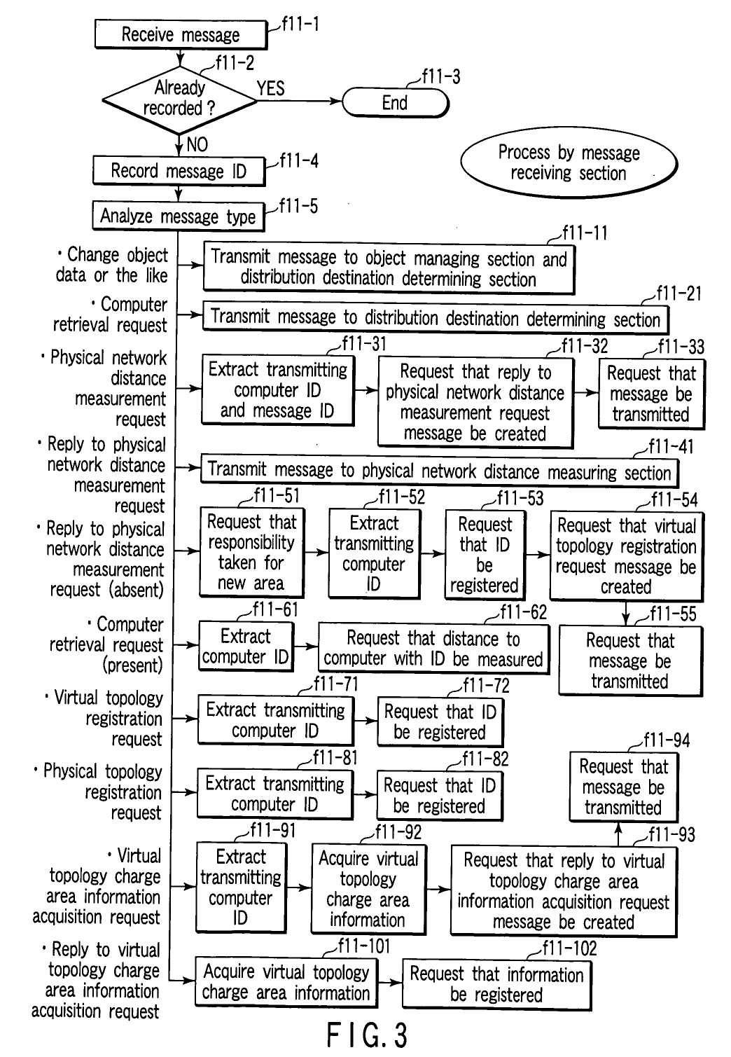

Specifically, as shown in FIG. 3, the message receiving section 11 has process functions (f11-1) to (f11-5) for reception and process functions (f11-11) to (f11-102) for received messages.

The process functions (f11-1) to (f11-5) for reception are as described below.

(f11-1) Upon receiving a message, the message receiving section 11 extracts its ID.

(f11-2) The message receiving section 11 determines whether the same message ID has been recorded in the message ID recording section.

(f11-3) If the message ID has already been recorded, the message receiving section 11 ends the process on this message because the same message has already been processed.

(f11-4) If the message has not been recorded yet, the message receiving section 11 records the message ID in the message ID recording section.

(f11-5) After recording, the message receiving section 11 extracts a message type from the message.

The process functions (f11-11) to (f11-102) are classified into 10 types in accordance with the message type.

(f11-11) If the message type is “Change object data”, “Add object data”, or “Delete object data”, the message receiving section 11 sends the message to the object managing section 24 and distribution destination determining section 16.

(f11-21) If the message type is “Computer retrieval request”, the message receiving section 11 sends the message to the distribution destination determining section 16.

(f11-31) to (f11-33) If the message type is “Physical network distance measurement return”, the message receiving section 11 extracts a message transmitting computer ID and the message ID from the message (f11-31). The message receiving section 11 then requests the message generating section 21 to generate a “Reply to physical network distance measurement request” message (f11-32). The message receiving section 11 requests the message transmitting section 12 to transmit the message generated to the message transmitting computer ID (f11-33).

(f11-41) If the message type is “Reply to physical network distance measurement request”, the message receiving section 11 sends the message to the physical network distance measuring section 18.

(f11-51) to (f11-55) If the message type ID “Reply to computer retrieval request (absent)”, the message receiving section 11 request the virtual topology charge area managing section 17 to take the responsibility for a new area (f11-51). Then, the message receiving section 11 extracts the message transmitting computer ID from the message (f11-52). The message receiving section 11 then requests the virtual topology adjacent computer managing section 13 to register the message transmitting computer ID (f11-53). The message receiving section 11 then requests the message generating section 21 to create a “Virtual topology registration request” message (f11-54). The message receiving section 11 requests the message transmitting section 12 to transmit the message generated to the message transmitting computer ID (f11-55).

(f11-61) and (f11-62) If the message type is “Reply to computer retrieval request (present)”, the message receiving section 11 extracts a computer ID from message contents (f11-61). Then, the message receiving section 11 then requests the physical network distance measuring section 18 to measure a physical network distance for each computer ID (f11-62).

(f11-71) and (f11-72) If the message type is “Virtual topology registration request”, the message receiving section 11 extracts the message transmitting computer ID from the message (f11-71). Then, the message receiving section 11 requests the virtual topology adjacent computer managing section 13 to register the message transmitting computer ID (f11-72).

(f11-81) and (f11-82) If the message type is “Physical topology registration request”, the message receiving section 11 extracts the message transmitting computer ID from the message (f11-81). Then, the message receiving section 11 requests the physical topology adjacent computer managing section 14 to register the message transmitting computer ID (f11-82).

(f11-91) to (f11-94) If the message type is “Virtual topology charge area information acquisition request”, the message receiving section 11 extracts the message transmitting computer ID from the message (f11-91). The message receiving section 11 then acquires virtual topology charge area information from the virtual topology charge area managing section 17 (f11-92). The message receiving section 11 requests the message generating section 21 to create a “Virtual topology charge area information acquisition request return” message (f11-93). Then, the message receiving section 11 requests the message transmitting section 12 to transmit the message generated to the message transmitting computer ID (f11-94).

(f11-101) to (f11-102) If the message type is “Virtual topology charge area information acquisition request return”, the message receiving section 11 acquires virtual topology charge area information from the message contents (f11-101). The message receiving section 11 requests the virtual topology adjacent computer managing section 13 to register the virtual topology charge area information (f11-102).

The message transmitting section 12 has a function for receiving a message and a destination computer ID from the message receiving section 11, the distribution destination determining section 16, the physical network distance measuring section 18, or the message generating section 21 and transmitting the message to a specified destination.

The virtual topology adjacent computer managing section 13 manages the computer ID of an adjacent computer in the virtual topology. The virtual topology adjacent computer managing section 13 can be accessed by the message receiving section 11 and the distribution destination determining section 16. Here, the computer ID specifies an adjacent computer, for example, its TCP connection or IP address. In this case, the computer ID is IP address information.

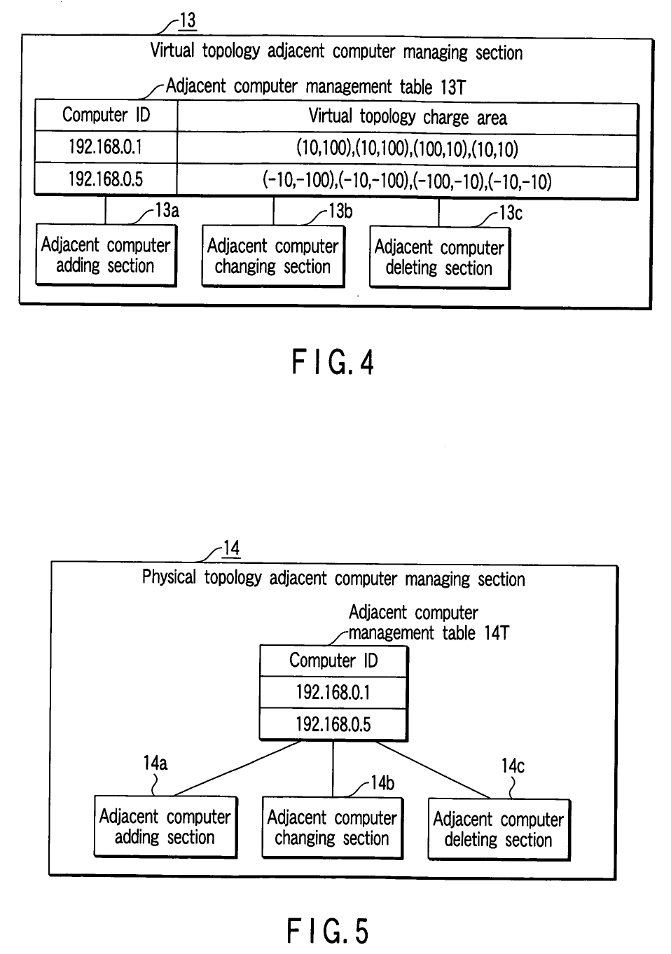

Specifically, as shown in FIG. 4, the virtual topology adjacent computer managing section 13 comprises an adjacent computer management table 13T, an adjacent computer adding section 13a, an adjacent computer changing section 13b, and an adjacent computer deleting section 13c.

The adjacent computer management table 13T can be accessed by the sections 13a to 13c. The following are registered in the adjacent computer management table 13T: the computer ID of an adjacent computer on the virtual topology and the virtual topology charge area of the adjacent computer. A column for the virtual topology charge area in the adjacent computer management table 13T can be omitted. This is because information on the virtual topology charge area may be acquired by transmitting the “Virtual topology charge area information acquisition request” message to the adjacent computer and extracting the information from the “Virtual topology charge area information acquisition request return” message, as required.

The adjacent computer adding section 13a adds the computer ID of the adjacent computer to an adjacent computer management table 13T. The adjacent computer adding section 13a has a function for, when requested to add a computer ID, rejecting the addition if a large number of adjacent computers have already been registered.

The adjacent computer changing section 13b has a function for changing contents registered in the adjacent computer management table 13T.

The adjacent computer deleting section 13c has a function for deleting contents registered in the adjacent computer management table 13T.

The physical topology adjacent computer managing section 14 manages the computer ID of an adjacent computer in the physical topology. The physical topology adjacent computer managing section 14 can be accessed by the message receiving section 11 and the distribution destination determining section 16. The computer ID is as previously described and is IP address information.

Specifically, as shown in FIG. 5, the physical topology adjacent computer managing section 14 comprises an adjacent computer management table 14T, an adjacent computer adding section 14a, an adjacent computer changing section 14b, and an adjacent computer deleting section 14c.

Computer IDs are registered in the adjacent computer management table 14T so that the sections 13a to 13c can access the IDs.

The adjacent computer adding section 14a has a function for adding the computer ID of an adjacent computer to the adjacent computer management table 14T. The adjacent computer adding section 14a also has a function for, when requested to add a computer ID, rejecting the addition if a large number of adjacent computers have already been registered.

The adjacent computer changing section 14b has a function for changing contents registered in the adjacent computer management table 14T.

The adjacent computer deleting section 14c has a function for deleting contents registered in the adjacent computer management table 14T.

The all-computers-in-virtual-topology-charge-area managing section 15 can be accessed by the distribution destination determining section 16. The all-computers-in-virtual-topology-charge-area managing section 15 manages the computer IDs of all the computers having virtual space coordinates in the virtual topology charge area.

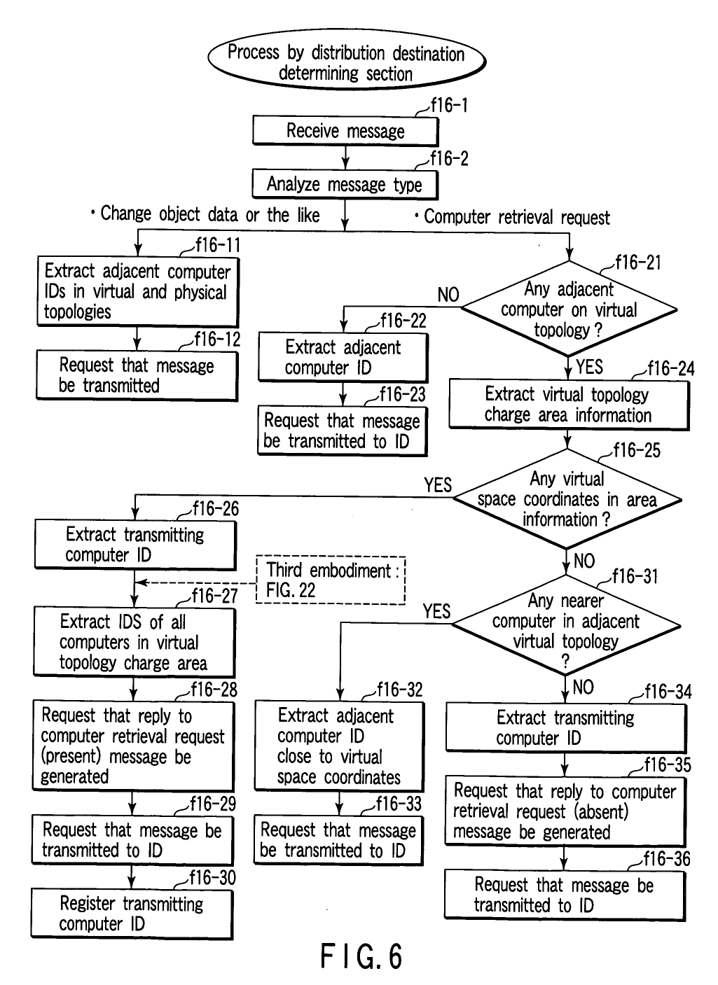

The distribution destination determining section 16 has a function for determining a computer to which a received message is distributed. Specifically, as shown in FIG. 6, the distribution destination determining section 16 has process functions (f16-1) and (f16-2) for reception and process functions (f16-11) to (f16-36) for determination of a distribution destination.

The process functions (f16-1) and (f16-2) for reception are as described below.

The distribution destination determining section 16 receives a message (f16-1). The distribution destination determining section 16 then extracts and analyzes the message type.

The process functions (f16-11) to (f16-36) for determination of a distribution destination are classified into two groups, the functions (f16-11) and (f16-12) and the functions (f16-21) to (f16-36), in accordance with the message type.

(f16-11) and (f16-12) If the message type is “Change object data”, “Add object data”, or “Delete object data”, the distribution destination determining section 16 extracts an adjacent computer ID from the virtual topology adjacent computer managing section 13 and physical topology adjacent computer managing section 14 (f16-11). The distribution destination determining section 16 requests the message transmitting section 12 to transmit a message to the adjacent computer ID extracted (f16-12).

(f16-21) to (f16-36) If the message type is “Computer retrieval request”, the distribution destination determining section 16 checks whether or not the virtual topology adjacent computer managing section 13 manages any adjacent computer (f16-21).

If the virtual topology adjacent computer managing section 13 does not manage any adjacent computer (f16-21; NO), the distribution destination determining section 16 extracts an adjacent computer ID from the physical topology adjacent computer managing section 14 (f16-22). The distribution destination determining section 16 then transmits data to the adjacent computer ID (f16-23).

If the virtual topology adjacent computer managing section 13 manages any adjacent computer (f16-21; YES), the distribution destination determining section 16 extracts virtual topology charge area information from the virtual topology charge area managing section 17 (f16-24). The distribution destination determining section 16 compares virtual space coordinates in the message with the virtual topology charge area information to determine whether or not the area information contains the virtual space coordinates (f16-25).

If the virtual space coordinates are present in the virtual topology charge area (f16-25; YES), the distribution destination determining section 16 extracts a transmitting computer ID from the message (f16-26). The distribution destination determining section 16 then extracts all the computer IDs from the all-computers-in-virtual-topology-charge-area managing section 15 (f16-27).

The distribution destination determining section 16 requests the message generating section 21 to create a “Computer retrieval request (present)” containing the all the computer IDs extracted and the computer ID of the computer 10 as message contents (f16-28).

The distribution destination determining section 16 requests the message transmitting section 12 to transmit the message generated to the transmitting computer ID (f16-29).

The distribution destination determining section 16 registers the transmitting computer ID in the all-computers-in-virtual-topology-charge-area managing section 15 (f16-30).

On the other hand, if the virtual space coordinates are not present in the virtual topology charge area (f16-25; NO), the distribution destination determining section 16 determines whether or not any of the adjacent computers managed by the virtual topology adjacent computer managing section 13 is responsible for a virtual topology charge area closer to the virtual space coordinates than the virtual topology charge area managed by the computer 10 (f16-31).

If any-adjacent computer has such a virtual topology charge area (f16-31; YES), the distribution destination determining section 16 determines the computer ID of the adjacent computer having a virtual topology charge area close to the virtual space coordinates (F16-32). In this case, two methods are available for determining the computer ID.

In one of these methods, a “Virtual topology charge area information acquisition request” message is transmitted to each adjacent request and a computer ID is extracted from a “Virtual topology charge area information acquisition request return” message obtained.

In the other method, a “Virtual topology charge area information acquisition request” message is transmitted, and the contents of a “Virtual topology charge area information acquisition request return” message obtained is recorded, in the adjacent computer management table of the virtual topology adjacent computer managing section 13.

It is possible to use either of the two methods for determining the computer ID. The number of computer IDs determined depends on a user's setting provided that it is at least one. After determining the computer ID, the distribution destination determining section 16 requests the message transmitting section 12 to transmit the message generated to the computer ID (f16-33).

If no adjacent computer has such a virtual topology charge area (f16-31; NO), the distribution destination determining section 16 extracts, from the message, the computer ID to which the message has been transmitted (f16-34). The distribution destination determining section 16 then requests that a “Reply to computer retrieval request (absent)” message be generated (f16-35). The distribution destination determining section 16 then requests the message transmitting section 12 to transmit the message generated to the above transmitting computer ID (f16-36).

The virtual topology charge area managing section 17 can be accessed by the message receiving section 11, the distribution destination determining section 16, and the virtual space coordinate managing section 20. The virtual topology charge area managing section 17 is composed of a virtual topology charge area holding section 17a and a unit area specification information managing section 17b.

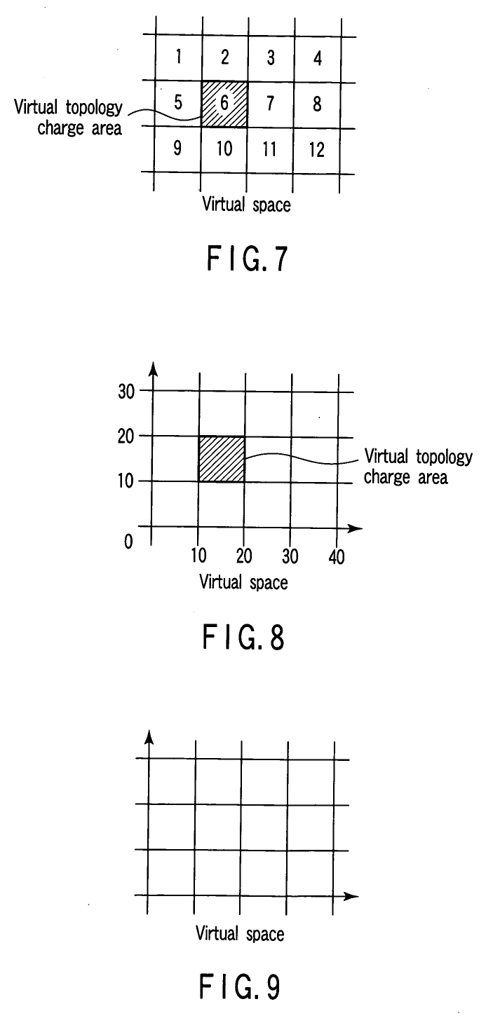

The virtual topology charge area holding section 17a indicates the virtual topology charge area to which the virtual space coordinates of the computer 10 belong. For example, an ID or coordinates may be used to indicate the virtual topology charge area. With the ID method, for example, as shown in FIG. 7, area IDs 1 to 12 are pre-assigned to all the virtual topology charge areas. Then, the virtual topology charge area is indicated by holding the area ID6. The ID method does not limit a specification target to an area but enables the specification of arbitrary targets such as buildings or grassy plains of arbitrary shapes on a virtual space. With the coordinate method, for example, as shown in FIG. 8, the virtual topology charge area is indicated by holding coordinates {(10, 10), (10, 20), (20, 10), (20, 20)} corresponding to the boundaries of the virtual topology charge area.

Upon receiving a virtual topology charge area information request, the virtual topology charge area holding section 17a returns virtual topology charge area information held by itself. Alternatively, a new virtual topology charge area may be specified. If a new virtual topology charge area is specified, the virtual topology charge area holding section 17a inputs virtual space coordinates to the unit area specification information managing section 17b. The virtual topology charge area holding section 17a then uses boundary information on a unit area obtained to set a virtual topology charge area. In the first and second embodiment, after using the boundary information to set the virtual topology charge area, the virtual topology charge area holding section 17a sets the same area in the simulation charge area managing section 23 of the virtual space simulator 22.

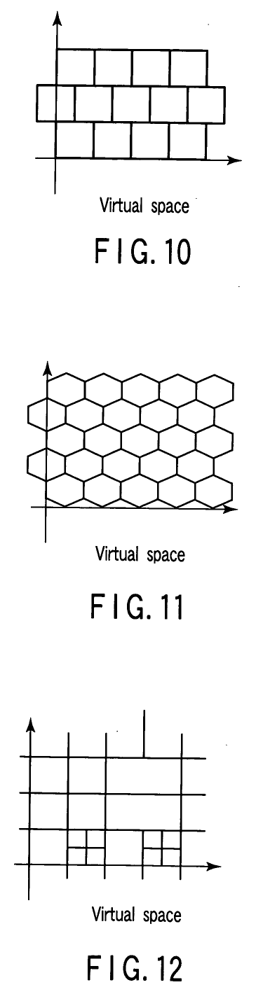

The unit area specification information managing section 17b specifies a method for dividing a virtual space into unit areas. Several methods for division are possible. If for example, the virtual space is two-dimensionally expressed, methods shown in FIGS. 9 to 12 may be used. FIG. 9 shows a method of dividing the virtual space into meshes. FIG. 10 shows a method by which adjacent meshes are offset from one another. FIG. 11 shows a method of dividing the virtual space into hexagons. FIG. 12 shows a method of dividing, in principle, the virtual space into meshes and in some cases, dividing the space into figures different from the principled ones. Methods different from those shown in FIGS. 9 to 12 may of course be used provided that the virtual space is divided into unit areas without any gaps or overlaps.

As shown in FIGS. 9 to 12, the unit area specification information managing section 17b has a function for managing boundary information individually specifying virtual space unit areas, a function for acquiring boundary information on a unit area containing the virtual space coordinates input by the virtual topology charge area holding section 17a, on the basis of the virtual space coordinates, and a function for returning the boundary information acquired to the virtual topology charge area holding section 17a.

The physical network distance measuring section 18 measures the distance between two computers on the physical network on the basis of all the computer IDs contained in the Computer retrieval request (present) message received from the message receiving section 11.

The physical network distance measuring section 18 has a function for requesting the message transmitting section 12 to transmit messages, a time measuring section (not shown) that measures the time having passed since transmission of a message to determine a physical network distance, and a function for writing the computer ID of a computer having the shortest of the measured physical network distances, to the physical topology adjacent computer managing section 14.

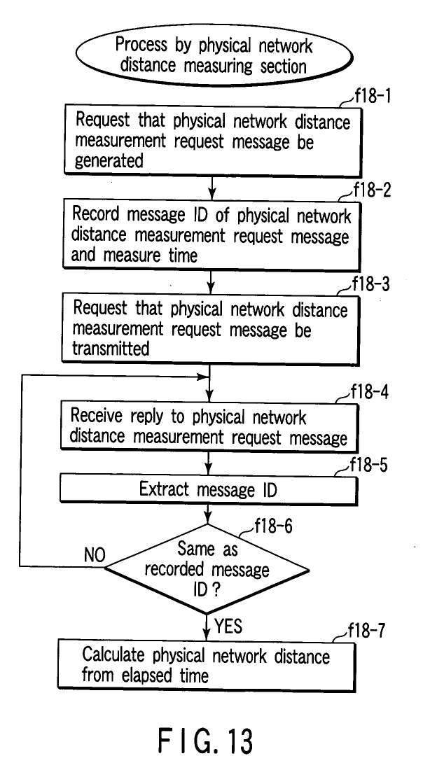

Specifically, as shown in FIG. 13, the physical network distance measuring section 18 has process functions (f18-1) to (f18-7). That is, the physical network distance measuring section 18 requests the message generating section 21 to generate a “Physical network distance measurement request” message (f18-1). The physical network distance measuring section 18 extracts a message ID from the message generated, records it, and starts measuring the time (f18-2).

The physical network distance measuring section 18 then requests the message transmitting section 12 to transmit the “Physical network distance measurement request” message to the computer for which the physical network distance is to be measured (f18-3).

The physical network distance measuring section 18 receives a “Reply to physical network distance measurement request” message (f18-4). Then, the physical network distance measuring section 18 extracts a message ID from the message (f18-5). The physical network distance measuring section 18 thus checks whether the message ID obtained is the same as the recorded one (f18-6). If the message IDs are the same (f18-6; YES), the physical network distance measuring section 18 ends measuring the time to calculate the elapsed time to obtain a physical network distance (f18-7). This calculating system is based on round-trip time. Alternatively, the current free bandwidth, the number of hops, or the like may be used to calculate the physical network distance.

The rendezvous computer list 19 manages the first computer ID to connect when new computers are allowed to participate in the topology. The rendezvous computer list 19 can be referenced by the message generating section 21. The rendezvous computer list 19 may be pre-specified in the computer or may be loaded from an external device at the time of connection.

The virtual space coordinate managing section 20 manages a pair of coordinates on the virtual space which corresponds to a computer on a one-to-one basis. The virtual space coordinate managing section 20 can be accessed by the object managing section 24 and message generating section 21. For an online game or the like, the virtual space coordinate managing section 20 manages the coordinates of avatars the operations of which are controlled by the computer user.

The message generating section 21 has a function for generating a message requested by the sections 11, 16, 18, 21, or the like and transmitting the message obtained to the message transmitting section 12 or distribution destination determining section 16, with reference to the virtual space coordinate managing section 20 or object managing section 24.

Here, the types of messages that can be generated by the message generating section 21 include “Change object data”, “Add object data”, “Delete object data”, “Physical network distance measurement request”, “Reply to physical network distance measurement request”, “Computer retrieval request”, “Reply to computer retrieval request (present)”, “Reply to computer retrieval request (absent)”, “All-computers-in-virtual-topology-charge-area retrieval request”, “All-computers-in-virtual-topology-charge-area retrieval request return”, “Physical topology registration request”, “Virtual topology registration request”, “Virtual topology charge area information acquisition request”, and “Virtual topology charge area information acquisition request return”. The details of each message will be described later.

The virtual space simulator 22 executes physical calculations on the virtual space and manages objects in the virtual space. The virtual space simulator 22 comprises a simulation charge area managing section 23 and an object managing section 24. The simulation charge area managing section 23 manages information indicating simulation charge areas.

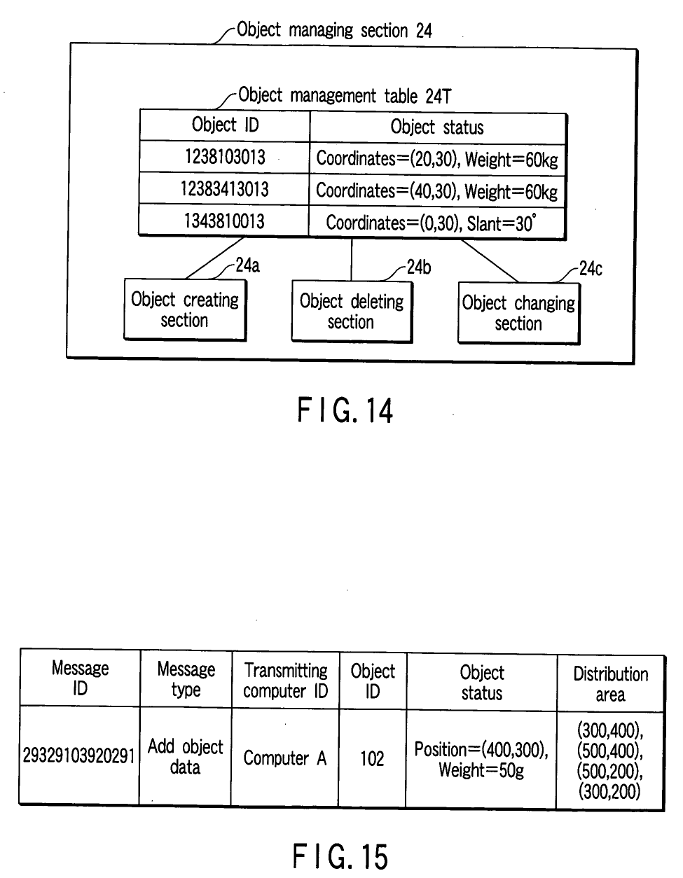

The object managing section 24 manages data on various objects present on the virtual space. The message receiving section 11 can input data on objects to the object managing section 24. The object managing section 24 can output data on objects to the virtual space coordinate managing section 20 and message generating section 21. As shown in FIG. 14, the object managing section 24 comprises an object management table 24T, an object creating section 24a, an object changing section 24b, and an object deleting section 24c.

The object management table 24T holds the status of each object on the basis of the object ID uniquely identifying the object. The sections 24a to 24c can write or read data to or from the object management table 24T. Here, the object ID is a sufficiently long numerical value. The status of an object is, for example, the coordinates of the object on the virtual space or the weight of the object.

The object creating section 24a creates the status of each object on the basis of its object ID and writes it to the object management table 24T.

The object changing section 24b changes the status of each object in the object management table 24T.

The object deleting section 24c deletes the status of each object from the object management ID on the basis of its object ID.

Upon receiving a “Change object data” message, the virtual space simulator 22 changes data on an object specified in the message. Upon receiving a “Create object data” message, the virtual space simulator 22 creates data on the object specified in the message. Upon receiving a “Delete object data” message, the virtual space simulator 22 deletes the data on the object specified in the message.

Before the data manipulation (change, create, or deletion), the virtual space simulator 22 may compare the simulation charge area for which it is responsible with the coordinates of the object and then execute the data manipulation only if the coordinates of the object are present in the simulation charge area and if the virtual topology adjacent computer managing section 13 manages adjacent computers. With this configuration, data on an object can be changed only by the computer to which the virtual topology is connected and for which the target object is present in its simulation charge area.

Now, each message will be described. As shown in FIG. 15, the message is divided into a message header section and a message contents section. All the messages have the message header section. The message header section has a message ID (that identifies the message), a message type (a value indicating the type of the message), and a transmitting computer ID (that indicates the computer having transmitted the message).

The message ID may have a sufficiently long random numerical value in order to maintain uniqueness. To further enhance the uniqueness of the message ID, it is possible to provide a counter in the message generating section 21 so that a value in the counter is incremented by one every time a message is generated and that a message ID is composed of a computer ID and the value in the counter which are arranged in series.

Now, the message contents section will be described. Information described as the message contents varies depending on the message type.

The message of the message type “Change object data” is used to request that the data on an object be changed. The contents of the message include an object ID identifying the object to be changed, and the contents of the change. The contents of the change include the name of the type of an attribute of the object, for example, “coordinate values” or “weight” and a value resulting from the change in attribute, for example, “(100, 200)” or “60 kg”.

The message of the message type “Add object data” is used to request that a new object be created. The contents of the message include an object ID identifying the object to be added and contents indicating an attribute of the object. The contents indicating the attribute are similar to the contents of the change in the case of “Change object data”.

The message of the message type “Delete object data” is used to request that an object be deleted. The message contents include an object ID identifying the object to be deleted.

The message of the message type “Physical network distance measurement request” is used to measure a distance in the physical network. The contents of the message include an ID (IP address or the like) identifying the computer having transmitted the message.

The message of the message type “Reply to physical network distance measurement request” is used by the computer receiving the Physical network distance measurement request message, as a return message. The contents of the message include the message ID of the corresponding “Physical network distance measurement request”.

The message of the message type “Computer retrieval request” is used by a new computer to participate in the topology. The contents of the message include virtual space coordinates.

The message of the message type “Reply to computer retrieval request (present)” is used to notify the transmitter of the Computer retrieval request message of all the computer IDs identifying all the computers in the virtual topology charge area managed by the computer 10 when the virtual topology charge area contains the virtual space coordinates described in the Computer retrieval request message. The message contents include the message ID of the “Computer retrieval request” massage and the IDs of all the computers present in the virtual topology charge area.

The message of the message type “Reply to computer retrieval request (absent)” is used to notify the transmitter of the Computer retrieval request message that the virtual topology charge area managed by the computer does not contain the virtual space coordinates described in the Computer retrieval request message and that no other computers manage a virtual topology charge area closer to the virtual space coordinates than that of the computer 10. The message contents include the message ID of the corresponding “Computer retrieval request” message.

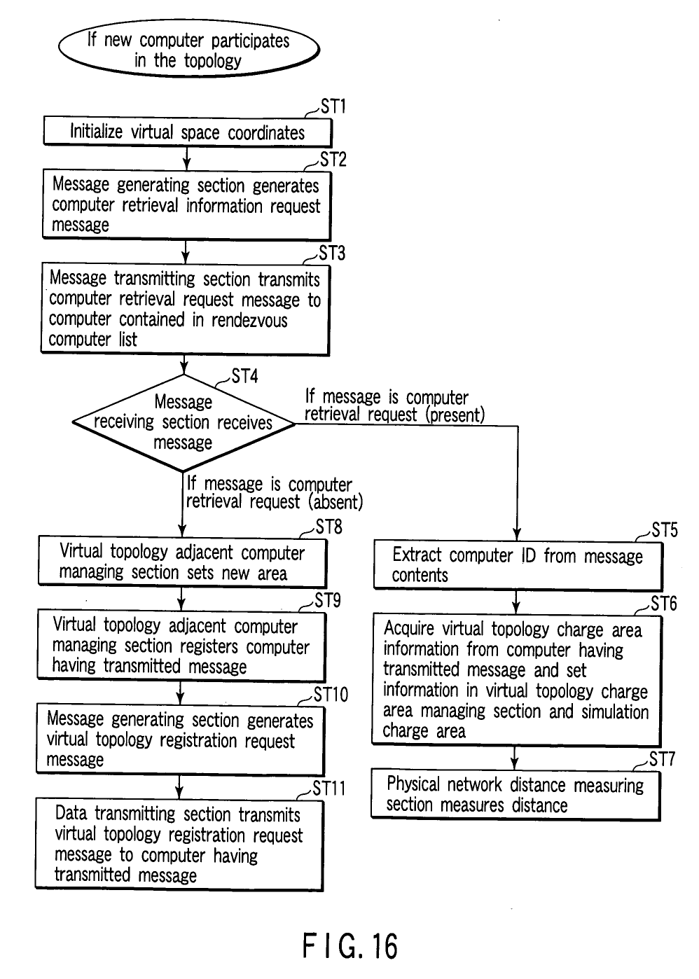

Now, with reference to FIGS. 16 to 19, description will be given of operations of the computer group configured as described above.

(If a New Computer Participates in the Topology)

First, with reference to the flowchart in FIG. 16, description will be given of operations performed when a new computer participates in the topology. The computer newly participating in the topology (referred to as the newly participating computer below) sets initial values for virtual space coordinates (ST1). The initial values may be specified by the user, predetermined by the computer, or loaded from an external application for setting initial values for virtual space coordinates. The set initial values are held by the virtual space coordinate managing section 20.

The newly participating computer causes the message generating section 21 to generate a Computer retrieval request message containing its own coordinate values on the virtual space (ST2).

The newly participating computer causes the message transmitting section 12 to transmit the Computer retrieval request message to a computer ID managed in the rendezvous computer list 19 (ST3).

The newly participating computer causes the message receiving section 11 to receive messages from computers on the virtual topology which are located in a virtual space unit area containing the coordinate values or in a virtual space unit area closest to the one containing the coordinate values (ST4). Subsequently, the newly participating computer analyzes the message to determine whether it is a Computer retrieval request (present) or Computer retrieval request (absent).

Description will be given of the case in which the message is Computer retrieval request (present) in step ST4.

The Computer retrieval request (present) message contains the computer IDs of all the computers responsible for the virtual space unit area containing the coordinate values of the newly participating computer.

The newly participating computer extracts all the relevant computer IDs from the message contents (ST5). The newly participating computer requests that a computer indicated by any of the computer ID provide boundary information on the virtual space unit area for which it is responsible. The newly participating computer then causes the virtual topology charge area managing section 17 to manage the boundary information obtained (ST6).

The newly participating computer causes the physical network distance measuring section 18 to measure the distances to all the computer IDs extracted (ST7). Subsequently, the newly participating computer causes the physical topology adjacent computer managing section 14 to register the computer ID of a computer having the shortest of the measured physical network distances, as an adjacent computer. The newly participating computer then transmits a physical topology registration request to the registered computer.

Description will be given of the case in which the message is a Computer retrieval request (absent) in step ST4.

The Computer retrieval request (absent) message is transmitted by an adjacent computer on the virtual topology which is located in a virtual space unit area closer to the one containing the coordinate values of the newly participating computer. The Computer retrieval request (absent) message contains the computer ID of the adjacent computer.

The newly participating computer causes the virtual topology charge area managing section 17 to determine the unit area containing the virtual space coordinates to be a virtual topology charge area (ST8).

The newly participating computer causes the virtual topology adjacent computer managing section 13 to register the computer having transmitted the received message, as an adjacent computer (ST9).

The newly participating computer causes the message generating section 21 to generate a “Virtual topology registration request” message. The newly participating computer then transmits, via the message transmitting section 12, the “Virtual topology registration request” message obtained to the computer having transmitted the message in step ST4.

Thus, the newly participating computer finishes the required operations. Now, Specific Examples 1 and 2 will be described.

### SPECIFIC EXAMPLE 1

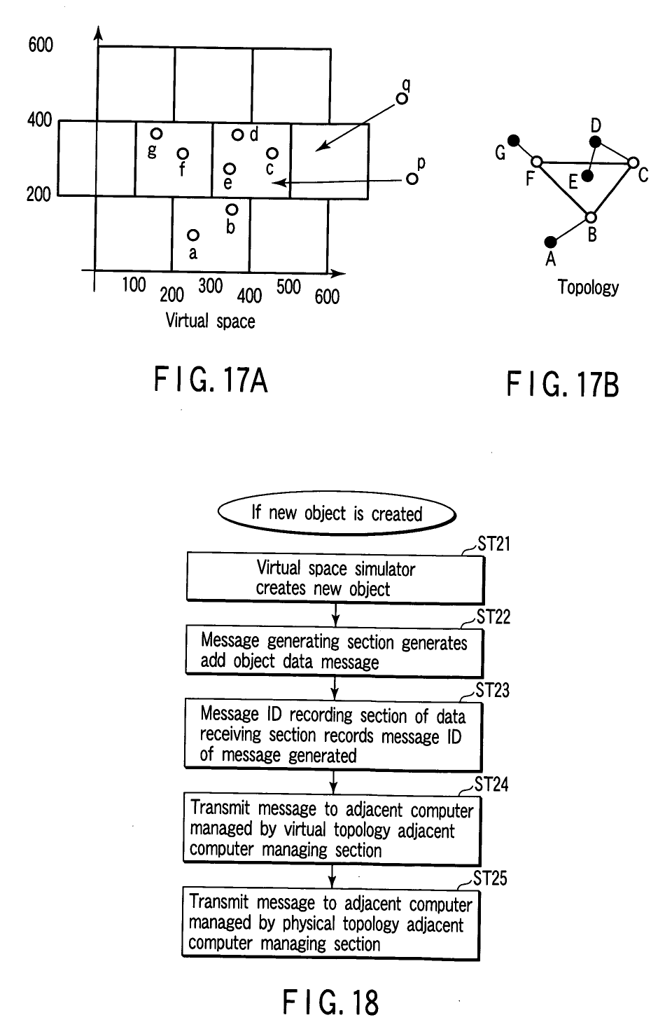

First, the situation of the specific example will be described. FIG. 17A shows that avatars a to e are present in a two-dimensional virtual space. Frame lines indicate unit areas into which the virtual space is divided.

The avatar a is managed by a computer A, the avatar b is managed by a computer B, . . . , and the avatar G is managed by a computer G. FIG. 17B shows a topology for the computers A to G.

A virtual topology establishes the connections between the computers B and C, between the computers C and F, and between the computers F and B. A physical topology establishes the connections between the computers A and B, between the computers C and D, between the computers D and E, and between the computers F and G.

In this state, it is assumed that an avatar p controlled by a new computer P newly appears at a coordinate position (420, 230) on the virtual space. It is also assumed that the computer A is set in the rendezvous computer list 19 of the computer P.

With reference to the rendezvous computer list 19, the computer P transmits a Computer retrieval request message to the computer A. In this case, the Computer retrieval request message contains the coordinate values of the computer P on the virtual space and its computer ID (information on the source address on the physical network).

The computer A receives the Computer retrieval request message. Then, the virtual topology adjacent computer managing section 13 has no adjacent computer ID. Accordingly, the computer A causes the message receiving section 11 and the distribution destination determining section 16 to execute their processes (f11-1 to d11-5 and f11-21) and (f16-1, f16-2 and f16-21 to f16-23), respectively, to distribute the message to the computer B, which is an adjacent computer in the physical topology.

The computer B receives the Computer retrieval request message. The computer B has an adjacent computer ID in the virtual topology adjacent computer managing section 13. Accordingly, the computer B takes boundary information (200, 200), (400, 200), (400, 0), and (200, 0), which corresponds to virtual topology charge area information, out of the virtual topology charge area managing section 17. In this case, the boundary coordinates are arranged in order of upper left, upper right, lower right, and lower left.

The computer B determines whether or not the virtual topology charge area contains the virtual space coordinates (420, 230) from the Computer retrieval request message. The virtual topology charge area does not contain the virtual space coordinates. Accordingly, the computer B determines which of the adjacent computers in the virtual topology manages an area closest to the virtual space coordinates (420, 230).

The computers C and F are adjacent to the computer B in the virtual topology. The computer C has an area closer to the virtual space coordinates (420, 230) than the computer F. Thus, the computer B transmits the Computer retrieval request message to the computer C.

The computer C receives the Computer retrieval request message. The computer C has an adjacent computer ID in the virtual topology adjacent computer managing section 13. Accordingly, the computer C takes virtual topology charge area coordinates (300, 400), (500, 400), (500, 200), and (300, 200) out of the virtual topology charge area managing section 13. This area contains the virtual space coordinates (420, 230) from the Computer retrieval request message.

Accordingly, the computer C creates a Computer retrieval request (present) message having as message contents the computer IDs of the computers C, D, and E, which are managed by the all-computers-in-virtual-topology-charge-area managing section 15. The computer C then transmits the Computer retrieval request (present) message to the computer P. The computer C additionally registers the computer P in the all-computers-in-virtual-topology-charge-area managing section 15.

The computer P receives the Computer retrieval request (present) message from the computer C. Subsequently, the computer P acquires the computer IDs of the computers C, D, and E from the message contents of the message. The computer P causes the physical network distance measuring section 18 to measure the physical network distances between P and C, between P and D, and between P and E. It is assumed that the physical network distance between P and D is determined to be shortest.

The computer P registers the computer D having the shortest physical network distance, as an adjacent computer in the physical topology. The computer then transmits a Physical topology registration request message to the computer D. The computer D receives the Physical topology registration request message and causes the physical topology adjacent computer managing section 14 to register the computer P. Specific Example 1 has been described in which the computer P participates in the topology.

### SPECIFIC EXAMPLE 2

Now, in the situation shown in FIGS. 17A and 17B, it is assumed that an avatar q controlled by a new computer Q newly appears at coordinate values (550, 330) on the virtual space. Description will be given of a process executed when the new computer Q participates in the topology. It is also assumed that the computer A is set in the rendezvous computer list 19 of the computer Q.

With reference to the rendezvous computer list 19, the computer Q transmits a Computer retrieval request message to the computer A. The computer A receives the Computer retrieval request message. The computer A, having received the message, has no adjacent computer in the virtual topology adjacent computer managing section 13. Accordingly, the computer A distributes the message to the computer B, which is an adjacent computer in the physical topology.

The computer B receives the Computer retrieval request message. The computer B has an adjacent computer ID in the virtual topology adjacent computer managing section 13. Accordingly, the computer B takes boundary information (200, 200), (400, 200), (400, 0), and (200, 0), which corresponds to virtual topology charge area information, out of the virtual topology charge area managing section 17.

The virtual topology charge area does not contain the virtual space coordinates (550, 330) from the Computer retrieval request message. Accordingly, the computer B determines which of the adjacent computers in the virtual topology manages an area closest to the virtual space coordinates (550, 330).

The computers C and F are adjacent to the computer B in the virtual topology. The computer C has an area closer to the virtual space coordinates (550, 330) than the computer F. Thus, the computer B transmits the Computer retrieval request message to the computer C.

The computer C receives the Computer retrieval request message. The computer C has an adjacent computer ID in the virtual topology adjacent computer managing section 13. Accordingly, the computer C takes virtual topology charge area coordinates (300, 400), (500, 400), (500, 200), and (300, 200) out of the virtual topology charge area managing section 13. This area does not contain the virtual space coordinates (550, 330) from the Computer retrieval request message. Thus, the computer C determines which of the computers in the virtual topology manages an area closest to the virtual space coordinates (550, 330).

The computers B and F are adjacent to the computer C in the virtual topology. However, of the computers C, B, and F, the computer C manages an area closest to the virtual space coordinates.

The computer C thus creates a Reply to computer retrieval request (absent) message containing its own computer ID. The computer C then transmits the message to the computer Q.

Upon receiving the Reply to a computer retrieval request (absent) message, the computer Q request the virtual topology charge area managing section 17 to take the responsibility for a new area.

The virtual topology charge area managing section 17 takes boundary information on the virtual space unit area in which the avatar q is present, out of the unit area specification information managing section. The boundary information is then held in the virtual topology charge area managing section 17.

Then, the computer Q registers the computer C, having transmitted the Reply to computer retrieval request (absent) message, in the virtual topology adjacent computer managing section 13. The computer Q transmits an Adjacent topology registration request message to the computer C.

The computer C receives the Adjacent topology registration request message and registers the computer Q in the virtual topology adjacent computer managing section 13.

Specific Example 2 has been described in which the computer Q participates in the topology. This completes description of the participation of a new computer. Now, description will be given of operations performed if a new object is created.

(If a New Object is Created)

Now, description will be given of a process for transmitting an “Add object data” message.

A computer having created an object adds data on the new object to the object managing section 24. The computer then propagates the message throughout the topology. FIG. 18 is a flowchart of the case in which a new object is created.

The virtual space simulator 22 of the computer creates a new object (ST21). The object creating section 24 of the object managing section 24 registers the newly created object in the object management table 24T.

The computer causes the message generating section 21 to create an “Add object data” message (ST22). The contents of the message include the status of the newly created object.

The computer causes the message ID recording section of the message receiving section 11 to record the message ID of the created message (ST23).

The computer causes the distribution destination determining section 16 to read the computer ID of an adjacent computer managed by the virtual topology adjacent computer managing section 13. The computer then causes the message transmitting section 12 to transmit the “Add object data” message to the read computer ID (ST24).

The computer causes the distribution destination determining section 16 to read the computer ID of an adjacent computer managed by the physical topology adjacent computer managing section 14. The computer then causes the message transmitting section 12 to transmit the “Add object data” message to the read computer ID (ST25).

The process executed if a new object is created is thus finished. If any object is changed or deleted, the same process is executed except for a message created.

(If an Add Object Data Message is Distributed)

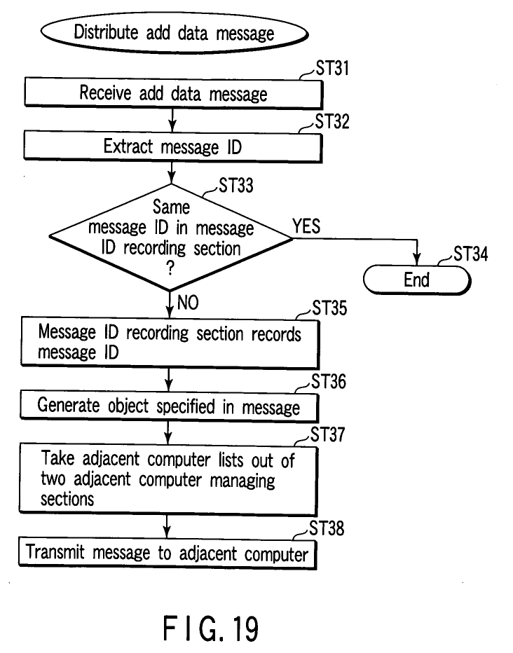

Now, with reference to FIG. 19, description will be given of the flow of a process executed to distribute an “Add object data” message.

The message receiving section 11 of the computer receives the “Add object data” message (ST31).

The computer extracts the message ID from the message (ST32). The computer then determines whether or not the same message ID is recorded in the message ID recording section (ST33).

If the determination indicates that the same message ID has already been recorded, the computer ends the distributing process (ST34).

On the other hand, if the determination indicates that the same message ID has not been recorded yet, the computer records the message ID from the received message in the message ID recording section (ST35).

Subsequently, the computer causes the object creating section 24a of the object managing section 24 to create an object specified in the message contents section of the message (ST36).

The computer further causes the distribution destination determining section 16 to extract an adjacent computer list indicating the computer IDs of adjacent computers managed by the virtual topology adjacent computer managing section 13 and physical topology adjacent computer managing section 14 (ST37).

The computer causes the message transmitting section 12 to transmit the message to the computer IDs contained in the extracted adjacent computer list (ST38).

The process for distributing the Add object data message is thus finished.

As described above, according to the first embodiment, a topology is constructed by determining not only virtual space coordinates but also physical network distances. Specifically, as shown in FIGS. 1A and 1B, the first embodiment adopts a connection form comprising a virtual topology in which representative computers connect virtual space unit areas into which a virtual space is divided and a physical topology in which the representative and remaining computers are connected together in the virtual space unit area.

Thus, when a message for an update (new creation, addition, change, deletion, or the like) is to be propagated to all the computers, if coordinate values in a virtual space unit area of the virtual space are smaller than a certain threshold, the message is distributed using the physical topology based on the physical network, as described in step ST25. Consequently, in contrast to the prior art, it is possible to avoid delaying operations in a computer which are related to those in another computer on the virtual space and taking a roundabout route on the physical network for distribution. The avoidance of a roundabout route makes it possible to reduce the amount of communication on the network.

If the coordinate values in the virtual space unit area of the virtual space exceed the certain threshold, the message is distributed using the virtual topology based on the virtual space, as described in step ST24. Consequently, the computers forming the physical topology can be limited to those present in the virtual space unit area. Compared to the prior art, it is possible to significantly reduce the amount of communication required to measure physical network distances. Further, only the computers present in the virtual space unit are used to construct a physical topology. This enables the topology to be inexpensively constructed.

Thus, the present embodiment uses the combination of the physical and virtual topologies. The present embodiment can thus avoid taking a roundabout route or causing a delay in data distribution between computers based on the P2P system while reducing the amount of communication required to measure distances, thus enabling prompt data updates.

For example, it is assumed that a large number of avatars are present in a broad view of a grassy plain or the like. If an avatar causes an operation of “raising its hand” to be reflected in the other avatars, it is more preferable to promptly transmit data to the whole group of avatars in the field of view than to cause the data to be sequentially reflected in the avatars starting with the nearest one. In other words, if the distances to the avatars are at most a certain threshold, it is more important to promptly transmit the data to all the avatars than to sequentially and promptly transmit the data to the avatars starting with the nearest one on the virtual space.

In the present embodiment, the data is distributed using the topology based on the physical network if the corresponding distance is at most the certain threshold or the topology based on the virtual space if the distance exceeds the certain threshold. Consequently, even in the above situation, the data can be transmitted to the whole group of avatars present in the field of view.

Further, according to the present embodiment, a newly participating computer can participate in the topology as shown in steps ST1 to ST9 and Specific Examples 1 and 2. The present embodiment enables a message for an object update to be propagated throughout the topology as shown in steps ST1 to ST25. The present embodiment enables a message for addition of object data to be propagated as shown in steps ST31 to ST38.

The first embodiment may be varied by omitting the physical topology adjacent computer managing section 14. This variation is the same as the first embodiment except that there are no adjacent computers managed by the physical topology adjacent computer managing section 14 and that the “Physical topology registration request” message is not processed.

Similarly, the first embodiment may be varied by omitting the virtual topology adjacent computer managing section 13. This variation is the same as the first embodiment except that there are no adjacent computers managed by the virtual topology adjacent computer managing section 13 and that the “Physical topology registration request” message is not processed.

The description of the present embodiment assumes that no avatars are present on the virtual space, that is, there are no managed computers in the virtual space unit areas. However, an embodiment is possible in which avatars are present in all the unit areas, that is, managed computers are present in all the virtual space unit areas.

### Second Embodiment

Now, the second embodiment will be described. The present embodiment is a variation of the first embodiment and propagates a message specifying a target area.

Specifically, with an application handling virtual spaces, for the convenience of a virtual space, the Change, Add, or Delete object data message needs to be distributed only to a part of the virtual space. In this case, the whole traffic of the message can advantageously be reduced by limiting the message distribution to this part of the virtual space. In the present embodiment, such a case will be described.

Specifically, the second embodiment has almost the same mechanism as that of the first embodiment except for the following two points.

1) Each of the Change, Add, and Delete data messages contains distribution area information.

2) Upon receiving the Change, Add, or Delete data message, the distribution destination determining section 16 determines a distribution destination on the basis of the distribution area information.

For 1), the message contents of the “Change object data” message include an object ID identifying an object to be changed, the contents of the change in object, and the distribution area information on the message.

The message contents of the “Add object data” message include an object ID identifying an object to be added, the contents of the object to be added, and the distribution area information on the message.

The message contents of the “Delete object data” message include an object ID identifying an object to be deleted and the distribution area information on the message.

Here, the distribution area information indicates an area on the virtual space. Any method can be used to indicate the area. For example, the area may be specified by using the coordinates of a center and a radius, numerating the coordinate values of four corners of the rectangular area, or specifying an area ID for the unit area.

Now, description will be given of a process executed when the distribution destination determining section 16 receives a Change, Add, or Delete object data message.

The distribution destination determining section 16 has a function for referencing the virtual topology adjacent computer managing section 13 and the physical topology adjacent computer managing section 14 on the basis of the distribution area information contained in the message received by the message receiving section 11, to read the computer ID of an adjacent computer in a virtual space unit area with boundary information corresponding to the distribution area information, from the virtual topology adjacent computer managing section 13 or the physical topology adjacent computer managing section 14. The distribution destination determining section 16 also has a function for requesting the message transmitting section 12 to distribute the message to the read computer ID.

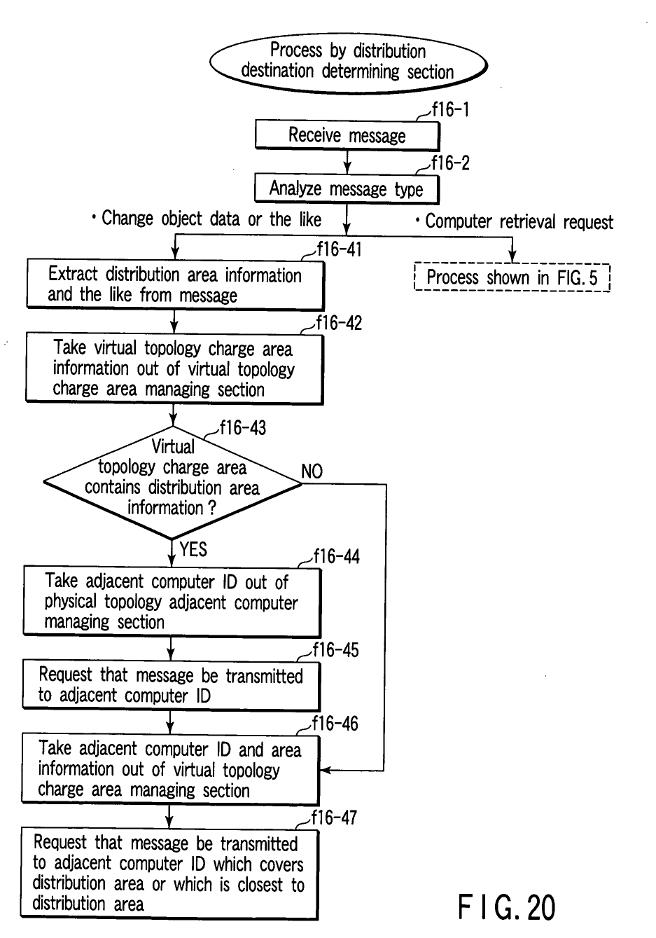

Specifically, as shown in FIG. 20, the distribution destination determining section 16 has functions (f16-41) to (f16-47), which are not shown in FIG. 6. These functions will be mainly described below.

(f16-41) The distribution destination determining section 16 extracts the distribution area information from the message.

(f16-42) The distribution destination determining section 16 takes virtual topology charge area information out of the virtual topology charge area managing section 17.

(f16-43) The distribution destination determining section 16 determines whether or not the virtual topology charge area contains the distribution area.

(f16-43; YES) The virtual topology charge area contains the distribution area.

(f16-44) The distribution destination determining section 16 takes an adjacent computer ID out of the physical topology adjacent computer managing section 14.

(f16-45) The distribution destination determining section 16 requests the message transmitting section 12 to transmit the message to the adjacent computer ID. The distribution destination determining section 16 then proceeds to the function (f16-46).

(f16-43; NO) The virtual topology charge area does not contain the distribution area.

(f16-46) The distribution destination determining section 16 acquires adjacent computer IDs and area information from the virtual topology adjacent computer managing section 13.

(f16-47) The distribution destination determining section 16 determines an adjacent computer ID which covers the distribution area or which is closest to the distribution area. The distribution destination determining section 16 then requests the message transmitting section 12 to transmit the message to this adjacent computer ID.

### Specific Example

Description will be given of the case in which in FIGS. 17A and 17B (the avatars p and q have not participated in the topology yet), the computer A, managing the avatar a, transmits a message throughout the topology.

It is assumed that the computer A generates an Add object data message as shown in FIG. 15. The Add data message indicates the addition of an object having an object ID 102 and for which the status is indicated by a position (400, 300) and a weight of 50 g, while the distribution area is indicated by (300, 400), (500, 400), (500, 200), and (300, 200).

The computer B is adjacent to the computer A in the physical topology, whereas no computers are adjacent to the computer A in the virtual topology. Thus, the computer A transmits the Add data message to the computer B.

The computer B causes the message receiving section 11 to receive the message. The distribution area does not contain the virtual topology charge area of the computer B. Accordingly, the computer B extracts the virtual topology charge areas of the computers C and F, which are adjacent to the computer B in the virtual topology.

The virtual topology charge area of the computer C is indicated by (300, 400), (500, 400), (500, 200), and (300, 200). The virtual topology charge area of the computer F is indicated by (100, 400), (300, 400), (300, 200), and (100, 200). The computer C is closer to the distribution area than the computer F. Accordingly, the computer B transmits the message to the computer C.

The virtual topology charge area of the computer C contains the distribution area. Accordingly, the computer C transmits the message to the computer D, which is adjacent to the computer C in the physical topology. The virtual topology charge area of the computer D contains the distribution area. Thus, the computer D transmits the message to the computer E, which is adjacent to the computer D in the physical topology.

The process for distributing the message containing the distribution area information is thus completed.

As described above, the present embodiment not only provides the effects of the first embodiment but also limits the message distribution destination to a part of the virtual space if the message is required only for this part. This reduces the amount of communication required.

Further, when a message specifying a distribution area is to be distributed, the virtual topology is used until the message from the source computer reaches the distribution area. Once the message reaches the distribution area, the physical topology is used. This enables the message to be efficiently propagated to the distribution area.

### Third Embodiment

Now, the third embodiment of the present invention will be described. The present embodiment is a variation of the first embodiment and dynamically changes the simulation charge area.

Specifically, according to the first embodiment, the simulation charge area of each computer remains unchanged. In contrast, according to the third embodiment, the simulation charge area is dynamically changed. However, the virtual topology charge area remains unchanged.

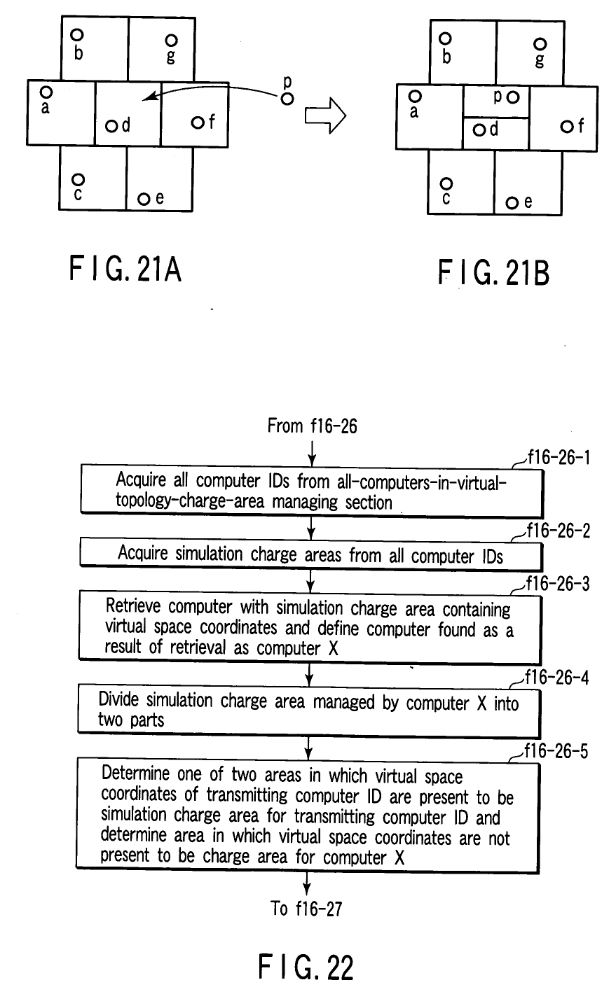

First, the third embodiment will be described in brief using an example shown in FIGS. 21A and 21B. FIG. 21A shows that the computers a to f manage the respective simulation charge areas and that the computer p participates in the simulation charge area managed by the computer d.

The participation of the computer p causes the computer d to divide its own simulation charge area into two parts as shown in FIG. 21B. Of the areas obtained, the one to which the computer p belongs is managed by the computer p. The remaining area is managed by the computer d.

Thus, in the third embodiment, when a new computer participates in a simulation charge area, the simulation charge area is divided into two parts. Then, the new computer takes the responsibility for the simulation area to which it belongs.

The third embodiment differs from the first and second embodiments in the following two points.

1) The message generating section 21 generates a “Simulation charge area acquisition request” message and a “Reply to simulation charge area acquisition request” message.

2) The distribution destination determining section 16 has functions (f16-26-1) to (f16-26-5) shown in FIG. 22, between the functions (f16-26) and (f16-27) for reception of the “Computer retrieval request” message, shown in FIG. 6.

These two points will mainly be described below.

1) The “Simulation charge area acquisition request” message and the “Reply to simulation charge area acquisition request” message comprise a message header section and a message contents section, similarly to the other messages.

The message header section has a message ID, a message type, and a message transmitting computer ID, as in the case of the other messages. The message type is “Simulation charge area acquisition request” or “Reply to simulation charge area acquisition request”.

The “Simulation charge area acquisition request” message has no contents.

The contents of the “Reply to simulation charge area acquisition request” include simulation charge area information. For example, if the simulation charge area is rectangular, the message contents include the coordinate values of the four corners of the rectangle.

2) In addition to the above functions, the distribution destination determining section 16 has a function for, when the coordinate values in the massage are contained in the virtual space unit area for which the computer 10 is responsible, requesting information on a simulation charge area on the virtual space from each computer ID in the all-computers-in-virtual-topology-charge-area managing section 15 and receiving the simulation charge area information from each computer ID, a function for selecting one of the pieces of simulation charge area information which contains the coordinate values from the message, a function for dividing the simulation charge area indicated by the selected simulation charge area information, into two parts on the basis of the coordinate values contained in the message, to obtain a first simulation charge area containing the coordinate values and the remaining second simulation charge area, a function for requesting the message transmitting section 12 to transmit first simulation charge area information indicating the first simulation charge area to the source of the message, and a function requesting the message transmitting section 12 to transmit second simulation charge area information indicating the second simulation charge area to the source of the selected simulation area information.

Specifically, as shown in FIG. 22, the distribution destination determining section 16 has a function to be added to a portion of FIG. 6 shown by a dotted arrow. That is, FIG. 22 shows a process to be added to the process executed when the distribution destination determining section 16 receives a Computer retrieval request message and if the virtual topology adjacent computer managing section 13 manages any adjacent computer and if the virtual space coordinates indicated in the message are present in the virtual topology charge area.

(f16-26-1) The distribution destination determining section 16 takes the computer IDs managed by the computer 10, out of the all-computers-in-virtual-topology-charge-area managing section 15.

(f16-26-2) The distribution destination determining section 16 acquires information on the simulation charge area of each computer from the group of computers indicated by the all the computer IDs taken-out. The information may be acquired by for example, transmitting a Simulation charge area acquisition request to the target computer and then receiving a reply.

(f16-26-3) The distribution destination determining section 16 checks which of the simulation charge areas acquired contains the virtual space coordinates. The distribution destination determining section 16 defines the computer managing the simulation charge area containing the virtual space coordinates, as a computer X.

(f16-24-4) The distribution destination determining section 16 divides the simulation charge area managed by the computer X into two parts. In this case, the simulation charge area can be divided in the following manner.

The distribution destination determining section 16 determines the midpoint between the virtual space coordinates of the computer X and the virtual space coordinates of the computer having transmitted the message. The distribution destination determining section 16 then determines one of the segments contained in the figure of the simulation charge area of the computer X which is longest and which passes through the midpoint. The distribution destination determining section 16 then determines a segment crossing the above segment at a right angle and uses it to divide the figure into two parts.

(f16-26-5) The distribution destination determining section 16 determines one of the two areas which contains the virtual space coordinates of the computer having a transmitting computer ID, to be the simulation charge area of the transmitting computer. The distribution destination determining section 16 determines the other area to be the simulation charge area of the computer X.

The above configuration cannot only exert the effects of the first embodiment but also make the newly participating computer X take the responsibility for a part of the existing simulation charge areas.

Note that the techniques described in the above-described respective embodiments are stored as programs which can be executed by computers in recording media such as magnetic disks (floppy (registered trademark) disks, hard disks, and the like), optical disks (CD-ROM/DVD and the like), optical magnetic disks (MO), semiconductor memories, and the like, and can be distributed.

Further, as the recording media, recording media which can store programs therein and out which computers can read may have any form of the storing system.

Further, middle ware (MW) or the like such as operating system (OS), database management software, network software, or the like, which is working on a computer on the basis of an instruction of the program installed in the computer from the storage medium may execute some of the respective processings for realizing the present embodiment.

Moreover, the recording media in the present invention are not limited to media independent of the computer, and recording media in which a program transmitted by LAN, Internet, or the like is downloaded, and stored or temporarily stored are included therein.

Further, the storage medium is not limited to one, and a case where the processings in the present embodiment are executed from a plurality of media is included in the storage medium in the present invention, and the medium configuration may be any configuration.

Note that, the computer in the present invention is to execute the respective processings in the present embodiment on the basis of the program stored in the storage medium, and may be any configuration of an apparatus formed from one such as a personal computer, a system in which a plurality of apparatuses are connected through a network, and the like.

Note that the computer in the present invention is not limited to a personal computer, and includes an arithmetic processing device, a microcomputer, and the like included information processing equipment, and is general term for equipment/apparatus which can realize the functions of the present invention by the program.

Note that the present invention is not limited to the above-described embodiments as are, and structural requirements can be modified and materialized within a range which does not deviate from the gist of the present invention at the practical phase. Further, various inventions can be formed due to the plurality of structural requirements which have been disclosed in the above-described embodiments being appropriately combined. For example, several structural requirements may be eliminated from all of the structural requirements shown in the embodiments. Moreover, structural requirements over different embodiments may be appropriately combined.

What is claimed is:

1. A method for distributing messages in which if a memory is provided and a plurality of computers each partly managing a virtual space are connected together, when a certain computer updates a status of the virtual space, a message for the update is distributed to the other computers by sequentially transmitting the message to an adjacent computer, the method comprising:
providing a virtual topology for a plurality of virtual space unit areas into which the virtual space is divided, the virtual topology being formed by connecting computers each representing the adjacent virtual space unit areas on the basis of coordinate values of each of the computers on the virtual space;
providing a physical topology for each of the virtual space unit areas, the physical topology being formed by connecting computers controlling, respectively, objects contained in the virtual space unit area on the basis of distances between the computers on a physical network;
storing address information on adjacent computers pre-connected adjacent to each computer on the virtual topology;
storing address information on adjacent computers pre-connected adjacent to each computer on the physical topology;
causing a certain adjacent computer to receive the message for the update;
causing the adjacent computer to extract a message ID from the message;
causing the adjacent computer to determine whether the same message ID has been recorded;
causing the adjacent computer to end a process on the message, when the same message ID has been recorded;
causing the adjacent computer to record the message ID, when the same message ID has not been recorded;
causing the adjacent computer to read information on an address of the adjacent computer on the virtual or physical topology from the memory on the basis of the message, when the same message ID has not been recorded; and
causing the adjacent computer to distribute the message to an adjacent computer on the basis of the read address information.

2. A computer used in a method for distributing messages in which if a plurality of computers each partly managing a virtual space are connected together, when a certain computer updates a status of the virtual space, a message for the update is distributed to the other computers by sequentially transmitting the message to an adjacent computer, the computer comprising:
a virtual topology adjacent computer storage device configured to store address information on adjacent computers connected adjacent to each computer on the virtual topology for a plurality of virtual space unit areas into which the virtual space is divided, the virtual topology being formed by connecting computers each representing the adjacent virtual space unit areas on the basis of coordinate values of each of the computers on the virtual space;
a physical topology adjacent computer storage device configured to store address information on adjacent computers connected adjacent to each computer on the physical topology for each of the virtual space unit areas, the physical topology being formed by connecting computers controlling, respectively, objects contained in the virtual space unit area on the basis of distances between the computers on a physical network;
an extracting device, receiving the message for the update, configured to extract a message ID from the message;
a determination device configured to determine whether the same message ID has been recorded;
an end device to end a process on the message, when the same message ID has been recorded;
a record device to record the message ID, when the same message ID has not been recorded;
a read device configured to read information on an address of the adjacent computer from each of the storage devices, when the same message ID has not been recorded; and
a device configured to distribute the message to an adjacent computer on the basis of the read address information.

3. The computer according to claim 2, further comprising:
a charge area storage device configured to store boundary information the virtual space unit area for which the computer is responsible;
a device configured to generate a computer retrieval request message containing coordinate values of the computer on the virtual space when the computer newly joins at least one of the topologies;
a device configured to transmit the computer retrieval request message,
a device configured to receive, after the transmission, a retrieval result “present” message containing address information on all computers responsible for a virtual space unit area containing the coordinate values, from a computer representing the virtual space unit area;
a device configured to request that a computer indicated by one of the pieces of address information in the retrieval result “present” message provide boundary information on the virtual space unit area for which the computer is responsible;
a device configured to write the boundary information obtained as a result of the request to the charge area storage device;
a device configured to measure physical network distances to all the computers indicated by all the pieces of address information in the retrieval result “present” message;
a device configured to write the address information on the computer having the shortest of the measured physical network distances to the physical topology adjacent computer storage device;
a device configured to receive a retrieval result “absent” message containing address information on an adjacent computer on the virtual topology, from this adjacent computer, after the computer retrieval request message has been transmitted; and
a device configured to write the address information on the adjacent computer in the retrieval result “absent” message to the virtual topology adjacent computer storage device.

4. The computer according to claim 3, further comprising:
an all-computers-in-charge-area storage device configured to pre-store address information on all the computers in the virtual space unit area for which the computer is responsible;
a device configured to receive a computer retrieval request message containing coordinate values of another computer on the virtual space which have been transmitted from this computer and address information on a source on the physical network;
a charge area determining device configured to determine whether or not the coordinate values in the computer retrieval request message are contained in the virtual space unit area for which the computer is responsible;
a device configured to return a retrieval result “present” message containing all pieces of address information stored in the all-computers-in-charge-area storage device, to the source address information, if the determination by the charge area determining device indicates that the coordinate values are contained in the virtual space unit area;
an adjacent area determining device configured to determine whether or not any of the adjacent computers is responsible for a virtual space unit area closer to the coordinate values than the one for which the computer is responsible if the determination by the charge area determining device indicates that the coordinate values are not contained in the virtual space unit area;
a device configured to, if the determination by the adjacent area determining device indicates that any of the adjacent computers is responsible for such a virtual space unit area, distribute the computer retrieval request message to this adjacent computer; and
a device configured to return a retrieval result “absent” message containing address information on the computer to the source address information if the determination by the adjacent area determining device indicates that none of the adjacent computers are responsible for such a virtual space unit area.

5. The computer according to claim 3, further comprising:
an all-computers-in-charge-area storage device configured to pre-store address information on all the computers in the virtual space unit area for which the computer is responsible;
a device configured to request information on a simulation charge area on the virtual area from each piece of address information in the all-computers-in-charge-area storage device and to receive the simulation charge area information, when the coordinate values in the message are contained in the virtual space unit area for which the computer is responsible;
a device configured to select one of the pieces of simulation charge area information which contains the coordinate values contained in the message;
a device configured to divide a simulation charge area indicated by the selected simulation charge area information, into two parts on the basis of the coordinate values contained in the message, to obtain a first simulation charge area containing the coordinate values and a remaining second simulation charge area;
a device configured to return first simulation charge area information indicating the first simulation charge area to a source of the message; and
a device configured to return second simulation charge area information indicating the second simulation charge area to a source of the selected simulation area information.

6. The computer according to claim 2, further comprising:
a device configured to receive a message containing distribution area information on the virtual space;
a device configured to reference each of the storage devices on the basis of the distribution area information contained in the message, to read, from the virtual topology adjacent storage device or the physical topology adjacent computer storage device, address information on an adjacent computer in the virtual space unit area which has boundary information corresponding to the distribution area information; and
a device configured to distribute the message to an adjacent computer on the basis of the read address information.

7. A program stored in a computer readable storage medium installed in a computer used in a system in which if a plurality of computers each partly managing a virtual space are connected together, when a certain computer updates a status of the virtual space, a message for the update is distributed to the other computers by sequentially transmitting the message to an adjacent computer, the program comprising:
a first program code which causes the computer to execute a process of providing a virtual topology adjacent computer storage area in which address information on adjacent computers connected adjacent to each computer on the virtual topology is stored for a virtual topology for a plurality of virtual space unit areas into which the virtual space is divided, the virtual topology being formed by connecting computers each representing the adjacent virtual space unit areas on the basis of coordinate values of each of the computers on the virtual space;
a second program code which causes the computer to execute a process of providing a physical topology adjacent computer storage area in which address information on adjacent computers connected adjacent to each computer on the physical topology is stored for a physical topology for each of the virtual space unit areas, the physical topology being formed by connecting computers controlling, respectively, objects contained in the virtual space unit area on the basis of distances between the computers on a physical network;
a third program code which causes the computer to execute a process of receiving the message for the update;
a fourth program code which causes the computer to execute a process of extract a message ID from the message;
a fifth program code which causes the computer to execute a process of determining whether the same message ID has been recorded;
a sixth program code which causes the computer to execute a process of ending a process on the message, when the same message ID has been recorded;
a seventh program code which causes the computer to execute a process of recording the message ID, when the same message ID has not been recorded;
an eighth program code which causes the computer to execute a process of reading information on an address of the adjacent computer from each of the storage areas, when the same message ID has not been recorded; and
a ninth program code which causes the computer to execute a process of distributing the message to an adjacent computer on the basis of the read address information.

8. The program according to claim 7, further comprising:
a tenth program code which causes the computer to execute a process of providing a charge area storage area in which boundary information the virtual space unit area for which the computer is responsible is stored;
an eleventh program code which causes the computer to execute a process of generating a computer retrieval request message containing coordinate values of the computer on the virtual space when the computer newly joins at least one of the topologies;
a twelfth program code which causes the computer to execute a process of transmitting the computer retrieval request message,
a thirteenth program code which causes the computer to execute a process of receiving, after the transmission, a retrieval result “present” message containing address information on all computers responsible for a virtual space unit area containing the coordinate values, from a computer representing the virtual space unit area;
a fourteenth program code which causes the computer to execute a process of requesting that a computer indicated by one of the pieces of address information in the retrieval result “present” message provide boundary information on the virtual space unit area for which the computer is responsible;
a fifteenth program code which causes the computer to execute a process of writing the boundary information obtained as a result of the request to the charge area storage area;
a sixteenth program code which causes the computer to execute a process of measuring physical network distances to all the computers indicated by all the pieces of address information in the retrieval result “present” message;
a seventeenth program code which causes the computer to execute a process of writing the address information on the computer having the shortest of the measured physical network distances to the physical topology adjacent computer storage area;
an eighteenth program code which causes the computer to execute a process of receiving a retrieval result “absent” message containing address information on an adjacent computer on the virtual topology, from this adjacent computer, after the computer retrieval request message has been transmitted; and
a nineteenth program code which causes the computer to execute a process of writing the address information on the adjacent computer in the retrieval result “absent” message to the virtual topology adjacent computer storage area.

9. The program according to claim 8, further comprising:
a twentieth program code which causes the computer to execute a process of providing an all-computers-in-charge-area storage area in which address information on all the computers in the virtual space unit area for which the computer is responsible is stored;
a twenty-first program code which causes the computer to execute a process of receiving a computer retrieval request message containing coordinate values of another computer on the virtual space which have been transmitted from this computer and address information on a source on the physical network;
a twenty-second program code which causes the computer to execute a first process of determining whether or not the coordinate values in the computer retrieval request message are contained in the virtual space unit area for which the computer is responsible;
a twenty-third program code which causes the computer to execute a process of returning a retrieval result “present” message containing all pieces of address information stored in the all-computers-in-charge-area storage area, to the source address information, if the determination by the first process of determining indicates that the coordinate values are contained in the virtual space unit area;
a twenty-fourth program code which causes the computer to execute a second process of determining whether or not any of the adjacent computers is responsible for a virtual space unit area closer to the coordinate values than the one for which the computer is responsible if the determination by the first process of determining indicates that the coordinate values are not contained in the virtual space unit area;
a twenty-fifth program code which causes the computer to execute a process of, if the determination by the second process of determining indicates that any of the adjacent computers is responsible for such a virtual space unit area, distributing the computer retrieval request message to this adjacent computer; and
a twenty-sixth program code which causes the computer to execute a process of returning a retrieval result “absent” message containing address information on the computer to the source address information if the determination by the second process of determining indicates that none of the adjacent computers are responsible for such a virtual space unit area.

10. The program according to claim 8, further comprising:
a twentieth program code which causes the computer to execute a process of providing an all-computers-in-charge-area storage area in which address information on all the computers in the virtual space unit area for which the computer is responsible is stored;
a twenty-first program code which causes the computer to execute a process of requesting information on a simulation charge area on the virtual area from each piece of address information in the all-computers-in-charge-area storage area when the coordinate values in the message are contained in the virtual space unit area for which the computer is responsible;
a twenty-second program code which causes the computer to execute a process of receiving the simulation charge area information in response to the request;
a twenty-third program code which causes the computer to execute a process of selecting one of the pieces of simulation charge area information which contains the coordinate values contained in the message;
a twenty-fourth program code which causes the computer to execute a process of dividing a simulation charge area indicated by the selected simulation charge area information, into two parts on the basis of the coordinate values contained in the message, to obtain a first simulation charge area containing the coordinate values and a remaining second simulation charge area;
a twenty-fifth program code which causes the computer to execute a process of returning first simulation charge area information indicating the first simulation charge area to a source of the message; and
a twenty-sixth program code which causes the computer to execute a process of returning second simulation charge area information indicating the second simulation charge area to a source of the selected simulation area information.

11. The program according to claim 7, further comprising:
a tenth program code which causes the computer to execute a process of receiving a message containing distribution area information on the virtual space;
a eleventh program code which causes the computer to execute a process of referencing each of the storage areas on the basis of the distribution area information contained in the message, to read, from the virtual topology adjacent storage area or the physical topology adjacent computer storage area, address information on an adjacent computer in the virtual space unit area which has boundary information corresponding to the distribution area information; and
a twelfth program code which causes the computer to execute a process of distributing the message to an adjacent computer on the basis of the read address information.
